(19) United States
(12) Patent Application Publication
(10) Pub. No.: US 2010/0049549 A1
(43) Pub. Date: Feb. 25, 2010

(54) PATIENT-CUSTOMIZED MEDICAL TREATMENT EDUCATION SYSTEM AND METHODS

(76) Inventor: Benjamin E. Nelms, Merrimac, WI (US)

Correspondence Address: WHYTE HIRSCHBOECK DUDEK S.C.;INTELLECTUAL PROPERTY DEPARTMENT, 33 East Main Street, Suite 300, Madison, WI, 53703-4655, US

(21) Appl. No.: 12/545,962

(22) Filed: Aug. 24, 2009

Related U.S. Application Data
(60) Provisional application No. 61/091,158, filed on Aug. 22, 2008.

(51) Int. Cl. G06Q 50/00

(52) U.S. Cl. 705/3

(57) ABSTRACT

A system and methods for generating a patient-specific and treatment plan-specific educational media montage for radiation is provided. The montage provides a multi-media documentary containing data specific to the radiation therapy treatment of a particular patient, which is based upon the specific medical scenario for that patient. Information relating to the patient's expectations before, during and after treatment is included. DICOM RT files are converted by the system and utilized for providing an educational documentary that is customizable to each patient.

### CROSS REFERENCE TO RELATED APPLICATIONS

The present application claims priority to U.S. Patent Application No. 61/091,158, filed on Aug. 22, 2008, titled Patient-Customized Medical Treatment Education System and Methods, which is hereby incorporated by reference in its entirety herein.

### FIELD OF THE INVENTION

The present invention relates to systems and methods for providing patient-specific treatment education. More specifically, the present invention relates to radiation therapy patient-specific education systems, methods and deliverables.

### BACKGROUND OF THE INVENTION

As medical treatments grow in complexity there is an increasing need for patient education relating to their medical therapies and treatment. It is often the case that patients enter into medical procedures without having a full understanding of the treatment they are about to undergo. Furthermore, patient's often fail to appreciate what is required of them during the treatment process, including activities before, during and after their actual treatment. With the increased availability of healthcare related information on the Internet, patients are often more inquisitive about their treatment, yet healthcare providers often have less time for one-on-one patient education. Medical treatments and procedures have varying effects upon the patient. Quite often, medical treatments are physically, emotionally, and psychologically difficult for the patient, which can lead to medical problems and financial consequences. By example, this is often the case for radiation oncology, as recent advances in technology have increased the complexity and types of treatment available.

Each patient undergoing radiation therapy is different, the health care workers have varying levels of expertise and preferences, and the health care facilities are often different, including varying radiation treatment modalities. Depending upon the patient's specific disease, the treatment prescribed, and the treatment methods, there is often a significant amount of information which can be provided to the patient in advance of undergoing treatment. Having knowledge of the treatment process, understanding the purpose of the treatment specific to the patient, and appreciating their role within the treatment can positively affect the success of a particular treatment.

Digital Imaging and Communications in Medicine (DICOM) files are a standard format for handling, storing, printing, and transmitting information in medical imaging. DICOM files can be exchanged between two entities that are capable of receiving image and patient data in DICOM format. DICOM enables the integration of scanners, servers, workstations, printers, and network hardware from multiple manufacturers into a picture archiving and communication system (PACS). The different devices come with DICOM conformance statements which clearly state the DICOM classes they support. DICOM has been widely adopted by hospitals and is making inroads in smaller applications like dentists' and doctors' offices. DICOM “RT” is a specific type of DICOM established for radiation therapy medical device operations. DICOM, and specifically DICOM RT, files have never directly been used to generate educational media and simulations for a patient's benefit.

Therefore, for the above reasons, it would be advantageous to have a system and method for providing a patient-specific interactive and educational montage. It would be further advantageous if the media montage was specific to radiation oncology and utilized industry specific file protocols. It would be advantageous to provide a customized education deliverable to a radiation therapy patient prior to starting the treatment process. It would be advantageous to provide an educational deliverable that is interactive and customized to an individual undergoing radiation therapy treatment, particularly in relation to the complex treatment devices and methods designed solely for them (i.e. specific to their imaging, treatment plan, immobilization, radiation delivery, and immobilization strategies). It would be further advantageous if the education deliverable was an electronic multi-media montage representing a substantial totality of the patient's specific treatment process. Yet another advantage would be gained by utilizing DICOM files to generate, at least in part, a customized education deliverable for healthcare patients.

### SUMMARY OF THE INVENTION

In at least one embodiment, the invention includes a method for generating patient-specific radiation therapy (RT) information. The method includes retrieving patient-specific healthcare related data, retrieving RT data associated with a patient, retrieving healthcare provider data based upon a patient-specific treatment plan and converting at least a portion of the retrieved data into computer readable media files. Additionally, the method includes generating a multimedia montage based on the converted data files. The multi-media montage incorporates the healthcare related data, RT data, and the provider data.

According to at least one embodiment, the invention includes a computing device with a central processing unit (CPU) for performing computer executable instructions. The device includes a treatment data storage means for storing radiation therapy data relating to at least one radiation therapy modality, a patient data storage means for storing healthcare related data associated with at least one patient and a provider data storage means for storing healthcare provider data. Additionally, the device includes a memory storage device for storing computer executable instructions that when executed by the CPU cause the CPU to generate a patient-specific radiation therapy media montage. Information contained within the montage is accessed from the treatment storage means, the patient storage means, and the provider storage means.

According to another embodiment, the invention includes a healthcare information delivery system with a central processing unit (CPU) for performing computer executable instructions. The delivery system includes a treatment data retrieval means for accessing and retrieving radiation therapy data relating to a radiation therapy modality, a patient data storage means having healthcare related information associated with at least one patient and a healthcare provider data storage means for storing provider related data. Additionally, the system includes a memory storage device for storing computer executable instructions that when executed by the CPU cause the CPU to generate a patient-specific media montage, wherein the montage is comprised of data accessed from the treatment data retrieval means, the patient data storage means, and the healthcare provider storage means.

According to at least one embodiment, the invention includes a method for providing medical information. The method includes providing a computer executable program, initiating the computer executable program comprising the steps of (1) accessing patient-specific healthcare related data, (2) accessing radiation therapy (RT) data associated with a patient, (3) accessing healthcare provider data based upon a patient-specific treatment plan, (4) converting at least a portion of the accessed data into computer readable media files and (5) generating a multimedia montage based on the data files, wherein the multi-media montage incorporates the healthcare related data, the RT data, and the provider data.

### BRIEF DESCRIPTION OF THE DRAWINGS

FIG. 1 is block diagram of the system in accordance with at least one embodiment of the invention;

FIG. 2 is a flow chart representing an exemplary method for generating patient-specific healthcare information in accordance with at least one embodiment of the present invention;

FIG. 3 is a flow chart representing an exemplary method for providing medical information in accordance with at least one embodiment of the present invention;

FIG. 4 is a flow chart representing an expanded exemplary methodology of the methods shown in FIG. 2 in accordance with at least one embodiment of the present invention;

FIG. 5 is a flow chart representing an expanded exemplary methodology of the methods shown in FIG. 2 in accordance with at least one embodiment of the present invention;

FIG. 6 is a flow chart representing an expanded exemplary methodology of the methods shown in FIG. 2 in accordance with at least one embodiment of the present invention;

FIG. 7 is a flow chart representing an exemplary method for selecting media and generating a multi-media montage in accordance with at least one embodiment of the present invention;

FIG. 8 is a flow chart representing an expanded exemplary methodology of the methods shown in FIG. 7 in accordance with at least one embodiment of the present invention;

FIG. 9 is a flow chart representing an exemplary multi-media montage sequence in accordance with at least one embodiment of the present invention;

FIG. 10 is a table displaying media assets and associated data in accordance with at least one embodiment of the present invention;

FIG. 11 is a table listing media assets in accordance with at least one embodiment of the present invention;

FIG. 12 is an exemplary workflow illustrating the process for generating and distributing a multi-media montage to an exemplary patient in accordance with at least one embodiment of the present invention;

FIG. 13 is another exemplary workflow illustrating the process for generating and distributing a multi-media montage to an exemplary patient in accordance with at least one embodiment of the present invention; and

FIG. 14 is yet another exemplary workflow illustrating the process for generating and distributing a multi-media montage to an exemplary patient in accordance with at least one embodiment of the present invention.

### DETAILED DESCRIPTION OF THE PREFERRED EMBODIMENT

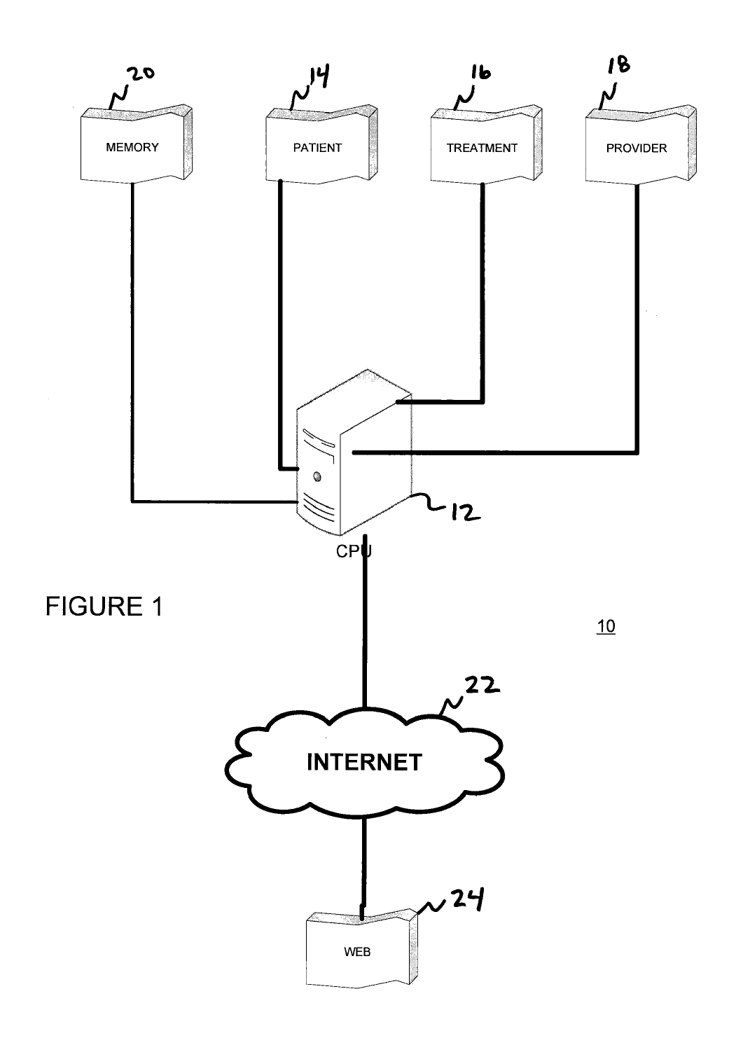

Referring to FIG. 1, a system 10 for generating a media montage is provided. The system 10 includes a central processing unit (CPU) 12, a patient data storage means 14, a healthcare treatment data storage means 16, a healthcare provider data storage means 18 and a memory storage device 20. The CPU 12 includes a web-interfacing connection to the Internet 22. Additionally, the system 10 includes a web-based data storage means 24, which provides access to data available through the Internet 22. The storage means 14, 16, 18, 20 are connected to the CPU 12, which can access and retrieve data from the storage means 14, 16, 18, 20. When executed by the CPU 12, computer executable instructions enable the CPU 12 to access and retrieve data from a plurality of data storage means 14, 16, 18, 20, 24 and create a multi-media montage. The CPU 12 performs computer executable instructions saved on the memory storage device 20. When the instructions are executed by the CPU 12, the CPU 12 generates the patient-specific radiation therapy media montage. The education module is a deliverable designed specifically for an individual patient. The deliverable can be in the form of a CR-ROM, flash drive or other suitable portable or web-accessible storage medium capable of retaining a file or set of files that can be executed by commonly available software. Commonly available software or multimedia framework can include, among others, QuickTime (Apple, Inc, Cuppertino, Calif.) and Windows Media (Microsoft Corp., Redmond, Wash.). Additionally, the deliverable can contain file formats selected from the group comprising MPEG, WMF, AV1, MP4, FLASH/SWF, MOV, JPEG, PDF and other known multi-media file formats. Based upon the education montage, the patient will learn specific information relating to their treatment. The media montage consists of a plurality of media types. In an alternative embodiment the montage is a uni-media montage, such as in the form of a paper hard-copy report.

Radiation therapy treatment is an exemplary area of healthcare, which is a complex and advancing field for which patient-specific documentaries could be used to educate patients about the treatment they will undertake, including the expectations for the patient. Various types of patient-specific and patient-neutral data can be used to create these documentaries. The multi-media montage is an electronic file generated by the CPU 12, which provides a documentary specific to each patient undergoing medical treatment. Data retrieved from the storage means 14, 16, 18, 20, 24 or an alternative source, is converted, formatted and organized based upon the computer executable instructions. Alternatively, the storage means 14, 16, 18, 20 can be a single data storage means (not shown). In an alternative embodiment, the montage is a plurality of files that are organized and provided in a format that allows patient interaction. In yet another alternative embodiment, it is contemplated that the montage does not reside on the system 10, but is provided to a patient as an interactive streaming video. It is further contemplated that the system and methods can be utilized for alternative areas of healthcare beyond radiation treatment therapy, which is provided as an exemplary healthcare field.

The storage means 14, 16, 18, 20 can be a database, a memory storage device, such as a CD-ROM, DVD, FLASH drive, a relational database, a PC or PDA file system or alternative memory storage devices. Alternatively, the storage means 14, 16, 19, 24 are data libraries accessed by the CPU 12 based upon the computer executable instructions.

The patient data storage means 14 contains data specific to healthcare patients. The data associated with at least one patient is stored within a relational database structure. Alternative database structures are also contemplated. Patient data is selected from a plurality of types including name, associated medical staff, imaging modalities experienced, immobilization techniques, IGRT techniques for use with a patient, treatment modality, picture of patient, and medical center associated with the patient. As an example, a patient undergoing radiation therapy treatment will have their picture taken and it will be saved in the storage means 14 and associated with various other types of data. Additionally, the storage means 14 includes patient biography information, past healthcare treatments, media simulations of the patient treatment procedure, training on the different duties for patient clinicians during all stages of the process, and interactive media reviews for a patient's own customized treatment plan (such as anatomy, radiation dose planned and beam arrangements), and follow-up steps prescribed by the patient's physician(s). The patient data storage means can also include DICOM RT files that contain patient-specific information. Generally speaking, patient data is comprised of patient-specific personal medical related data (non-DICOM) and DICOM RT files.

The treatment storage means 16 includes radiation treatment data associated with at least one patient. Information in the storage means 16 includes the library of media specific to devices and methods used by the healthcare providers specific to a particular patient. Generally speaking, radiation therapy treatment data includes information associated with treatment of the patient and medical imaging. Most radiation treatment data is formatted as DICOM files, which is a standard for handling, storing, printing and transmitting information related to medical imaging. Specifically, DICOM 3 is the current standard of medical imaging files. DICOM RT is specific to radiation therapy, and the industry-specific files include RT plan, RT structure, RT dose, and RT image. Each of these files are available as data inputs to the system 10, which can be located in the treatment storage means 16 or accessed from an alternative source. By example, the RT plan can include treatment modality, also referred to as the treatment machine; the number, order and names of radiation delivery beams; the parameters for each beam, which can include the gantry angle, couch angle, collimator angle, isocenter location, and machine monitor units; and delivery details for each beam, which can include the intensity modulation and the rotations during treatment. The RT structure set can include the name, colors and contour data for all the anatomy regions of interest (ROI). The RT dose data can include the 3D dose grid of dose values. In an alternative embodiment, it is contemplated that the patient data storage means 14 and treatment storage means 16 are a single database, a memory storage device, relational database, a PC or PDA file system or alternative memory storage device/means.

The provider storage means 18 includes healthcare worker and healthcare facility related data. The entire library of media specific to a healthcare provider's staff, location, and logistics is included within the storage means 18. The provider data includes a plurality of data types relating to the healthcare providers involved with the treatment of a patient's healthcare needs. Using the radiation therapy example, the following types of provider data are contemplated for purposes of generating a multimedia montage: healthcare provider pictures, healthcare worker identification, including radiation oncologists, imaging modalities, contact information for healthcare providers, healthcare facility maps and directories, radiation treatment modalities, follow-up steps for the patient specific to healthcare facilities, and additional data related to healthcare providers. Healthcare facilities can be selected from a group comprising hospitals, clinics, cancer-specific treatment centers, and alternative medical facilities where patient data is created and/or stored.

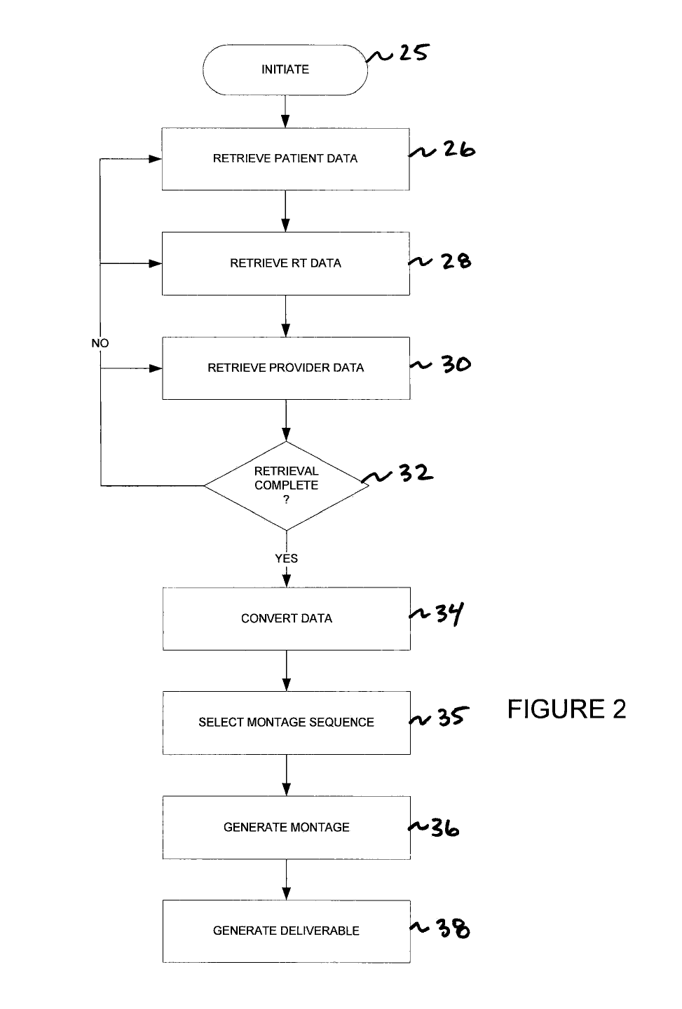

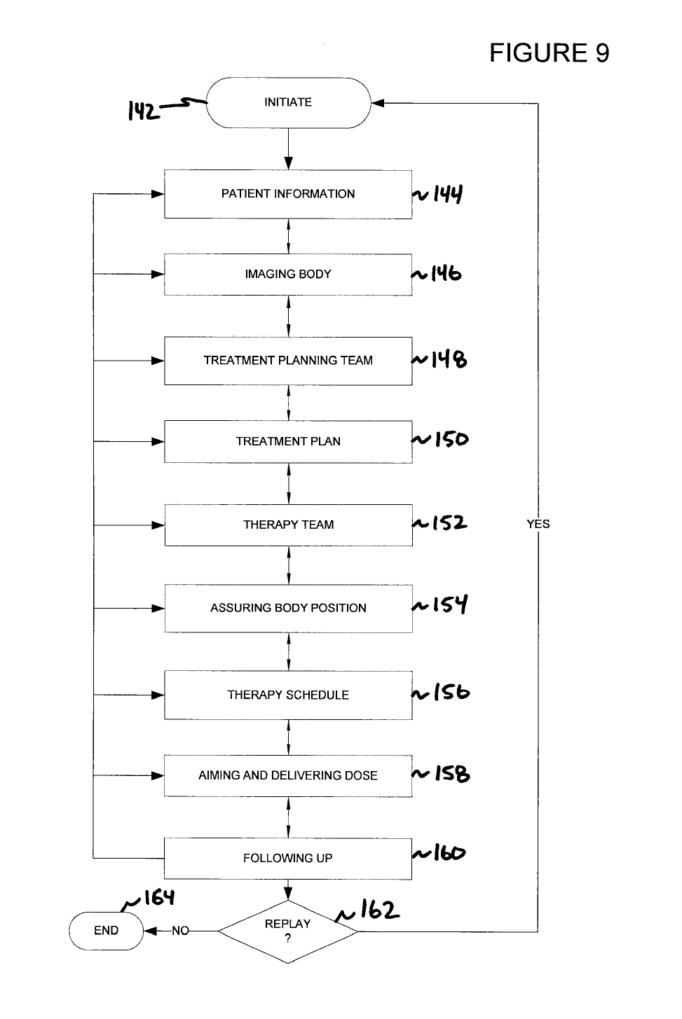

Referring to FIG. 2, an exemplary flow diagram of a method for generating a patient-specific healthcare information deliverable is provided. The method can be executed by the CPU 12. Initiation of the method occurs at step 25 and patient data is retrieved at step 26. Radiation therapy data is retrieved at step 28 followed by the retrieval of healthcare provider data at step 30. It is contemplated that the sequence of steps 26, 28 and 30 are interchangeable. A determination is made at step 32 as to whether data retrieval has been completed. In the event that data retrieval is not complete, any one of steps 26, 28 and 30 can be repeated. If retrieval is completed, data conversion occurs at step 34. Depending upon the format of the patient data, the provider data, and the RT data, all or a portion of the collective data is converted into an alternative format. Specifically, the DICOM RT files include a significant amount of information that is retrieved and converted for use within the patient's customized multi-media montage. After data conversion occurs at step 34 the default multi-media montage is generated at step 36. Alternatively, a user can modify the default montage sequence (See FIG. 9) at step 35. The user can select, or customize, the montage sequence by removing or adding modules. By example, if a healthcare provider's team photo was out-dated, this could be removed from the sequence. In another example, a non-standard immobilization technique may be utilized, and a new module added to the sequence.

The multi-media montage can reside as a single file or a plurality of connected files, which can be initiated for interaction and viewing through a graphical user interface (not shown). An alternative step 38 is provided, at which a deliverable is generated. The montage deliverable can be any storage means commonly used for storing electronic data. Alternatively, the montage deliverable can be in the form of a FTP or Internet link that allows a user to access and view the montage. It is contemplated that the deliverable can also include executable code for viewing and interaction with a plurality of computing systems, such as PC, MAC, PDA, iPhone/iTouch, and DVD player.

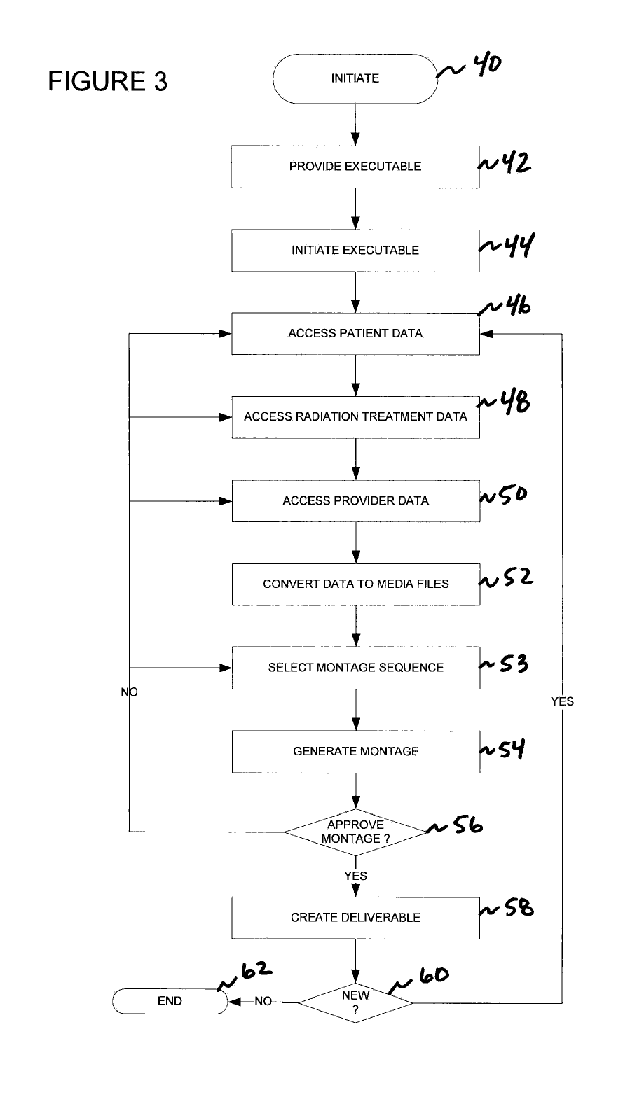

Referring to FIG. 3, a flow diagram representing an exemplary method for providing medical information is provided. The method is initiated at step 40 and a computer executable instruction is provided at step 42. The executable is initiated at step 44 by the CPU 12. After initiating the executable patient data is accessed at step 46. The patient data is accessed from the patient data storage means 16 at step 46, or from an alternative data source having patient related data. RT data is accessed at step 48 from the RT data storage means 14, or from an alternative data source having RT data. Healthcare provider data is accessed at step 50 from the provider storage means 18, or from an alternative data source having healthcare provider related data. Alternatively, a single storage means (not shown) holds all data necessary for generating a multi-media montage. It is further contemplated that patient, RT, and/or healthcare provider data can be accessed from a web-based server, having a unique IP address, or alternatively, provided automatically and dynamically through a data download. The server can alternatively be referred to as a DICOM Daemon in which files are passed between servers. It is contemplated that the sequence of steps 46, 48 and 50 are interchangeable. At step 52 data files are converted to an alternative file format, such as media files. By example, FLASH, .jpeg, .mov, .mpeg, .wmf, .avi, .wmv, .pdf and other multi-media file formats can be used. At step 53, the healthcare provider can select the montage sequence and/or customize the montage storyboard. Alternatively, a default storyboard sequence is generated. A multi-media montage is generated at step 54. The multi-media montage can reside as a single file or a plurality of associated files, which can be initiated for interaction and viewing through a graphical user interface (not shown). A determination of whether all the data has been accessed, and whether the montage is approved, is made at step 56. In the event of approval, a deliverable is created at step 58. If all the data has not been accessed then step 46 is repeated. In an alternative embodiment, the media montage deliverable is in the form of a hard-copy paper report.

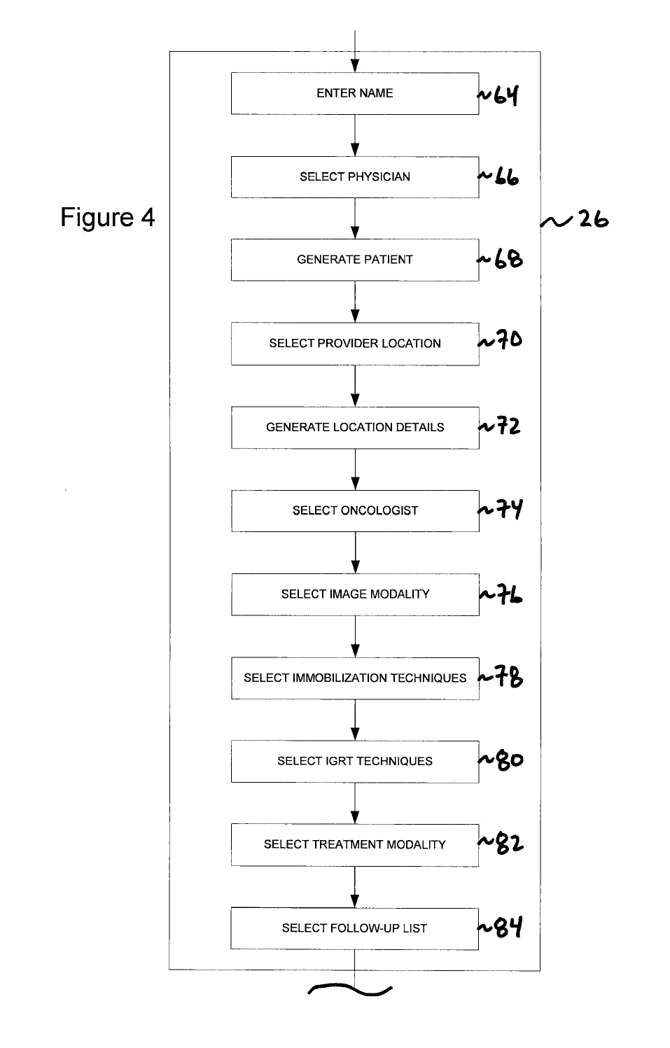

Referring to FIG. 4, an expanded exemplary methodology of retrieving patient data at step 26 is provided. The patient's name or alternative identification, such as a medical record number, is entered into the system 10 through a user interface (not shown) at step 64. The patient's physician is selected at step 66 followed by a patient record being generated at step 68. Alternatively, the patient records are preexistent within the patient data storage means. The patient provider location is selected at step 70 and a details relating to the location of the provider are generated at step 72. Location details can include street maps, facility maps, and driving directions from the patient's home or alternative location. In the event that there are multiple provider locations that the patient intends to visit, a directional map can be provided for each location and between locations. The patient's oncologist is selected at step 74 and the imaging modality experienced by the patient is selected at step 76. The patient can have image data generated by more than one imaging modality, in which case each modality can be selected. Immobilization techniques are selected at step 78. By selecting a specific or limited sect of available immobilization techniques the patient will be provided with multi-media educational sections within the montage specific to those techniques. The patient is able to appreciate the need and importance of being immobilized prior to having treatment, which ultimately provides a less stressful treatment experience for the patient and enables more effective treatment. This is especially true where treatment modalities are highly dependent upon accurate radiation dose delivery. Image guided radiation therapy (IGRT) techniques are selected at step 80. Alternatively, techniques for additional radiation treatment processes can be selected. At step 82 the treatment modality is selected. Alternatively, the sequence of steps 78, 80, and 82 can be interchanged. The immobilization techniques selected can depend upon the method of treatment and the treatment modality employed.

In an alternative embodiment, additional steps (not shown) relating to prior patient experiences can be added to the montage. By example, previous patient interviews and recordings can be provided to aid current patients with their treatment. Video and audio recordings of patients who have undergone a variety or specific procedures and treatments can be saved for use within a montage for a current patient. The previous patient interviews and recordings could assist current/future patients with similar diseases and treatments, which could add comfort to patients by seeing that others have experienced the same treatment and have prevailed. The interviews can include information relating to all aspects of healthcare. By example, interviews relating to treatment devices, disease states, immobilization and treatment clinics can be provided. During the creation of a particular customized montage, a previous patient interview can be added as a separate chapter/module within the patients montage/documentary.

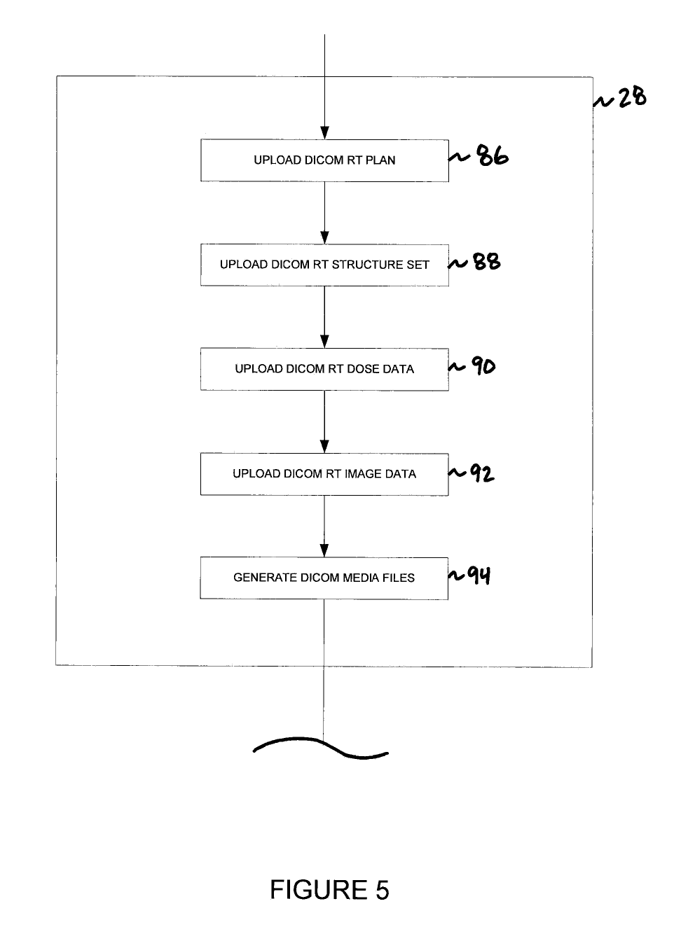

Referring to FIG. 5, an expanded exemplary methodology of retrieving treatment data at step 28 is provided. At step 86 the DICOM RT plan data is uploaded. DICOM RT plan data includes information on treatment machine model, treatment modality (photon, electron, particle modalities, for example), delivery method (such as static fields and rotational), beam geometry, beam exposure levels (monitor units), intensity-modulation specifications (MLC positions or beam modifiers), fractionation schedule and sub-groups. The DICOM RT structure set data is uploaded at step 88. DICOM RT structure set includes delineations of patient anatomy, critical volumes, targets, and interest points, and their respective locations within the patient matrix. The DICOM RT dose data is uploaded at step 90. The DICOM RT dose data includes data matrices describing the calculated planned dose values for voxels within the patient matrix. DICOM RT image files are uploaded at step 92. DICOM RT image files include treatment-relevant images such as portal films (electronic or scanned hardcopy films), and digitally reconstructed radiographs. DICOM RT files include a significant amount of information. For purposes of generating a multi-media montage the CPU 12 executes a program which accesses and retrieves the information needed within the DICOM RT files. The DICOM data is accessed from the treatment data storage means 14. This data can be retrieved from servers, the treatment storage means, or from an alternative data source. Data retrieved from these DICOM RT sources are used to generate the treatment simulations and the patient plan review media components of the system. In particular, the beam specifics, including geometry, exposure, modality, machine model and intensity modulation, the anatomy definitions, including structure/contour data and placement in patient matrix, structure names, structure outline colors, and the dose, including values and position in space relative to anatomy.

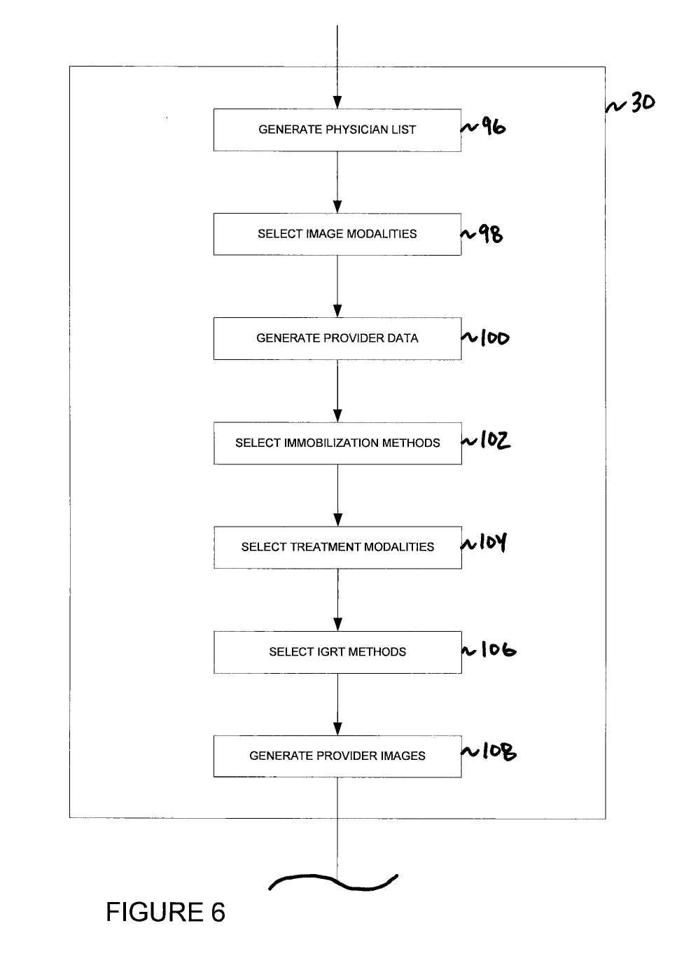

Referring to FIG. 6, an expanded exemplary methodology of retrieving provider data at step 30 is provided. At step 96 a physician list is generated, which is followed by selection of the available image modalities for a particular provider at step 98. A physician or alternative healthcare provider can have selected educational information available to the patient based upon the image modality selected. Provider data is generated at step 100, which can include contact information, location, and additional data associated with the provider. Treatment specifics are dependent upon the provider, as providers do not have the same technology and facilities. The provider's available immobilization methods are selected at step 102. At step 104 the provider's available treatment modalities are selected. Available IGRT methods are selected at step 106. Images associated with the provider are generated at step 108. Alternatively, medical center data can include the medical center's logo, a map of the Center, picture of the planning team and a picture of the therapy team.

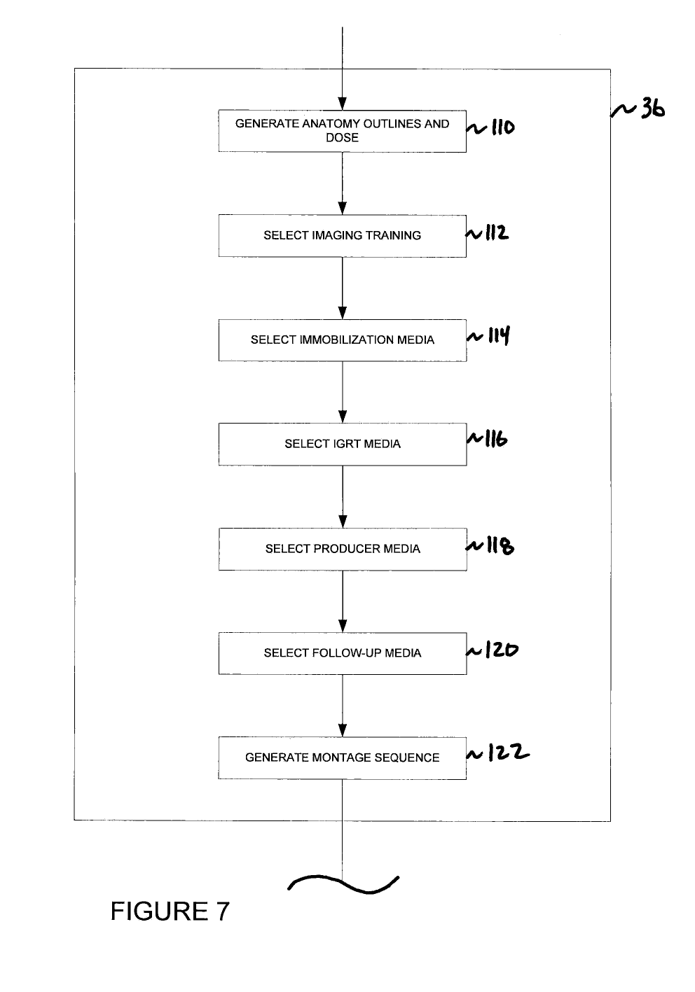

Referring to FIG. 7, an exemplary methodology for selecting media and generating the multi-media montage is provided. At step 110 anatomy outlines and dose are generated based upon the treatment plan data, At step 112 imaging training media is selected. Imaging training media provides multi-media information relating to the imaging modality selected. At step 114 immobilization technique media is selected, which provides a 2D and animation of what the patient is to expect for particular immobilization techniques. By knowing the expected immobilization prior to treatment the patient can anticipate their role in delivering radiation therapy treatment. At step 116 the IGRT media is selected, which provides multi-media information relating to IGRT. Healthcare provider data is selected at step 118 and follow-up media is selected at step 120. Provider media can include pictures and animation of the healthcare providers and the facilities, including interior images of the facilities where the patient will receive treatment. Follow-up media can include images of the patient's treatment calendar as well as images relating to alternative facilities the patient must visit. After the various media assets have been generated and selected the montage sequence is generated at step 122.

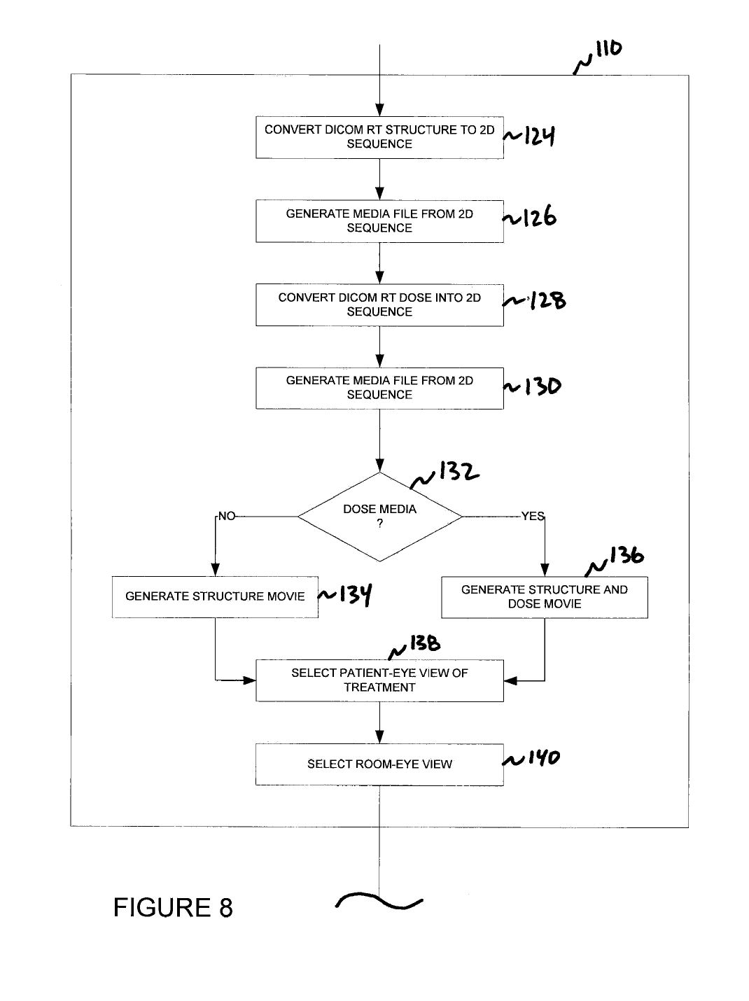

Referring to FIG. 8, an exemplary methodology of step 110 is provided. Selected DICOM RT structure data is converted into sequences of 2D images, to form animations, in axial, sagittal, or coronal orientations at step 124 and a media file containing these images is converted into sequences of 2D images, to form animations, and a media file is generated at step 126. At step 128 the selected DICOM RT dose data is converted into 2D images files and a media file containing these images is generated at step 130. A determination of whether to generate an animation with both structure media and dose media is made at step 132. If dose media is not included, then a structure animation is generated at step 134. If the dose media is included, then a combined structure and dose animation is generated at step 136. Animations and images of the patient-eye-view of the provider facilities and treatment modalities is selected at step 138. The animations and images include both sights and sounds of what the patient is to expect when undergoing treatment. A room-eye view of the facilities is selected at step 140. By example, RT structure ROIs are processed into 2D image files and the individual 2D structure images are processed into a movie sequence.

Radiation therapy utilizes image guidance through various modalities. Understanding the nature of the image guidance is beneficial to the patient's overall knowledge of their treatment. Image guidance animation is an additional media asset available as part of the education module. By example, image guidance animation can include orthogonal (substantially right angle) imaging means, ultrasound imaging, cone beam computed tomography (CBCT) imaging, and CT guided intensity modulated radiation therapy (IMRT), also referred to as Helical Tomo Therapy. By knowing the type of imaging and delivery of radiation treatment the patient is better suited to understand the nature of their treatment and appreciate the steps that are taken during the treatment process.

Referring to FIG. 9, an exemplary multi-media montage sequence is provided. The sequence can be viewed continuously or by individual interactive segments, which includes moving forward or backwards in the sequence, and skipping ahead or behind. The sequence is initiated at step 142 and followed by the patient's information at step 144. Imaging information related to the patient's body is provided at step 146. Media relating to the treatment planning team, including pictures of the team and biographical information can be provided at step 148 followed by media related to the treatment plan at step 150. The therapy team is presented at step 152. Media related to immobilization techniques and assuring the correct body position during treatment is provided at step 154. A therapy schedule is provided at step 156. Detailed information relating to the delivery of radiation treatment and dose is provided at step 158. Treatment follow-up information is provided at step 160. A determination whether to repay the sequence is made at step 162. If replay is selected then the sequence reverts back to step 144. If replay is not selected, then the sequence is terminated at step 164. It is contemplated that a user can access any of the sequence steps at any point in the sequence. Additionally, multi-media is provided with the montage that enables user interaction. By example, step 158 can include animation and movies which can be selected by the user to display the audio and visual experience relating to delivering treatment by the exact machine expected to be used on the patient, as well as providing the room-eye view of the treatment facilities that the patient will visit. In an alternative embodiment, the multi-media montage provides a educational documentary incorporating the complex treatment devices and methods designed solely for a particular patient, including the patient's imaging, treatment plan, immobilization, radiation delivery, and immobilization strategies.

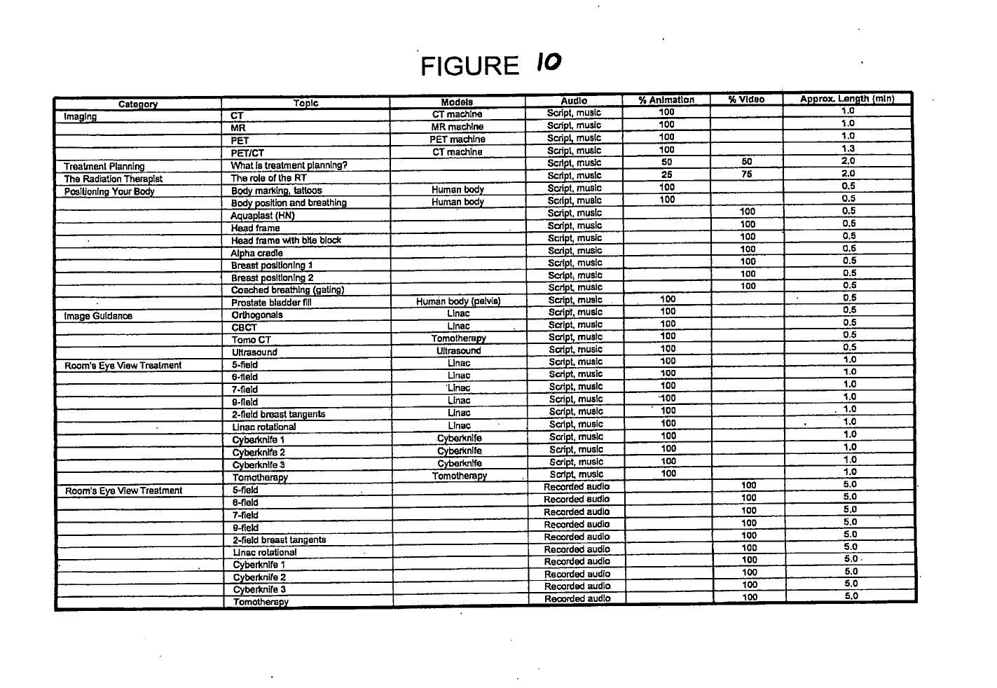

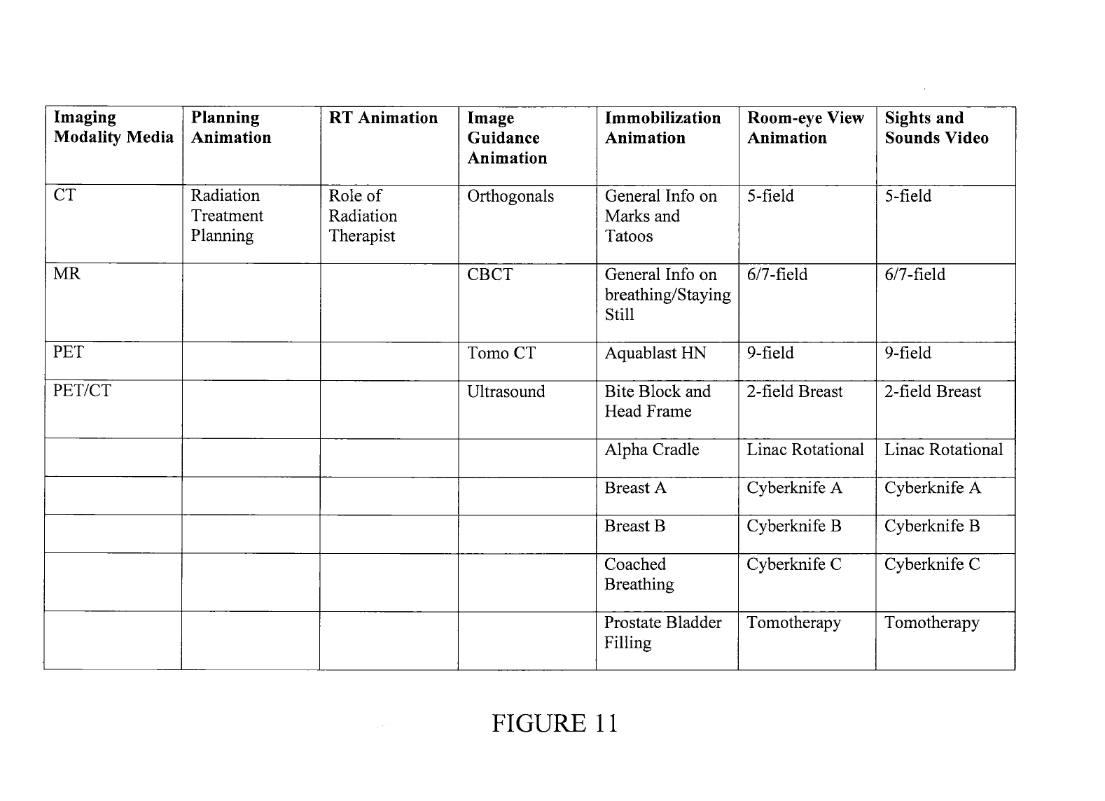

Referring to FIG. 10, a table is provided with an exemplary list of multimedia asset categories for the education module, including details relating to the audio and visual components. By example, the imaging modalities can include computed tomography (CT) imaging, magnetic resonance imaging (MRI), positron emission tomography (PET), and a combination of PET and CT imaging. The therapy planning animation provides an animated multimedia experience which provides the patient with greater knowledge about how the patient's radiation therapy is generated. In addition, medical professionals, such as radiation therapists, play a significant role in the therapy and treatment of patients undergoing radiation therapy. One of the media assets includes a multimedia presentation of the role and activities of medical professionals, such as radiation therapists, in the treatment and planning of patient care. Referring to FIG. 11, an alternative exemplary listing of available media asset types is provided.

Based in part upon the expanding medical modalities the system 10 is capable of receiving a plurality of data in various forms. Media assets are generally referred to as the data and information relating to the patient and/or treatment of the patient. From these media assets a patient education module is formed. The patient education module is a multimedia experience which incorporates a wide variety of data. As an example, a patient undergoing radiation therapy can have media assets selected from the following group, which include imaging modality media, therapy planning animation, medical professional animation, image guidance animation, patient immobilization animation, treatment location image animation, and multimedia audio and visualization of treatment procedures.

During radiation therapy accurate imaging of the patient and delivery of the radiation treatment are two of the most critical steps in the treatment process. In most cases patients are neither sedated nor restrained for treatment delivery. As a result, immobilization is often under the patient's control. Educating the patient as to the type of immobilization necessary, the nature of the immobilization and the reasons for the immobilization improves the treatment process. Patients are more apt to remain immobilized and are less stressed, as they are in more control of the situation. Furthermore, this results in more accurate imaging and more accurate radiation treatment delivery. Animations and multimedia presentations can be provided for a wide variety of patient immobilizations. Although, immobilization can differ depending upon the patient, the type of treatment, and the treatment modalities. By example, the following is an exemplary list of immobilization topics: patient breathing and avoiding body movements, bite blocks and head frame utilization, aquaplast and alpha cradle utilization, coached breathing (gating), and discussion of tattoos and body markings.

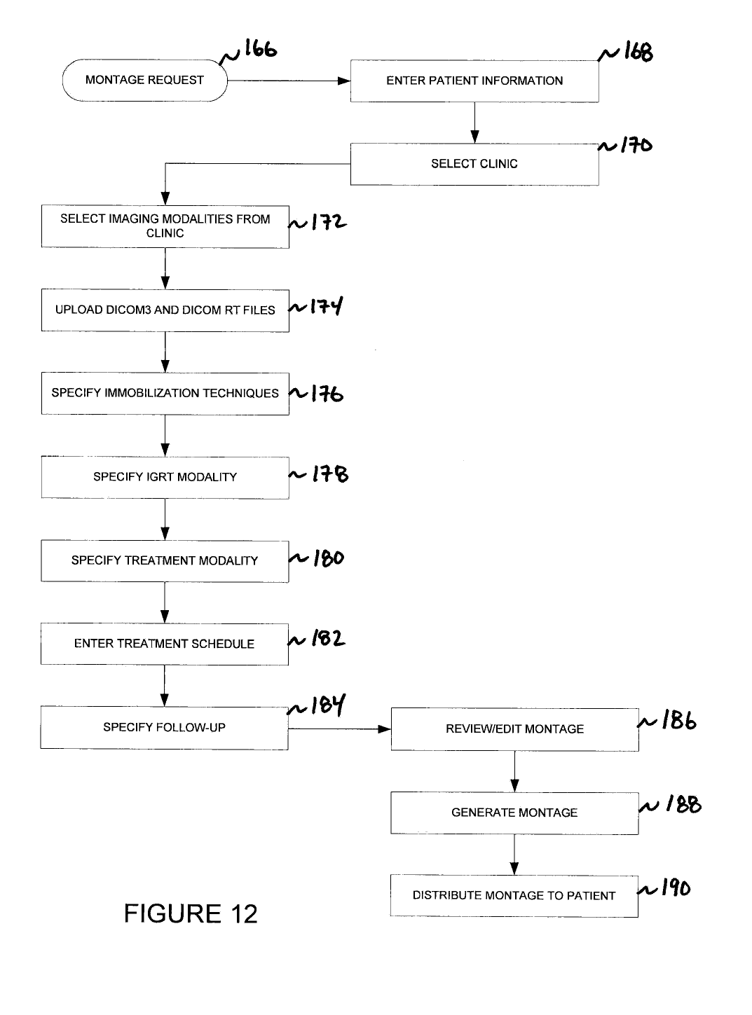

Referring to FIG. 12, an exemplary sequence is provided showing the process of generating a multi-media montage for a patient. A request is made for patient Benjamin Alpha at step 166. Mr. Alpha's information, including name, referring physician and picture are uploaded at step 168, followed by selecting the clinic at step 170. The first three steps represent an initialization phase, followed by content generation phase, which starts with step 172. At this step, the specific imaging modalities are selected from the clinic's library. The clinic's library represents the data specific to the particular clinic, or clinics, where Mr. Alpha is being treated. At step 174 the DICOM3 and DICOM RT files are uploaded. At step 176 the immobilization techniques from the clinic's library are uploaded, followed by specifying the IGRT modality from the clinic's library at step 178. The treatment modality is selected from the clinic's library at step 180, followed by entering a treatment schedule at step 182. A calendar widget can be used for step 182. At step 184, follow-up instructions for Mr. Alpha are selected from the clinic's library. The content, sequence and overall storyboard for the montage is reviewed and/or edited at step 186. Depending upon the clinic, Mr. Alpha and the treatment, a healthcare provided could edit the montage. By example, if a particular clinic location has been moved, the location map and pictures of the clinic can be updated. Mr. Alpha's montage is generated at step 188, followed by delivering it to him at step 190. In Mr. Alpha's case, he has chosen to receive the montage on a CD-ROM for viewing on his laptop computer.

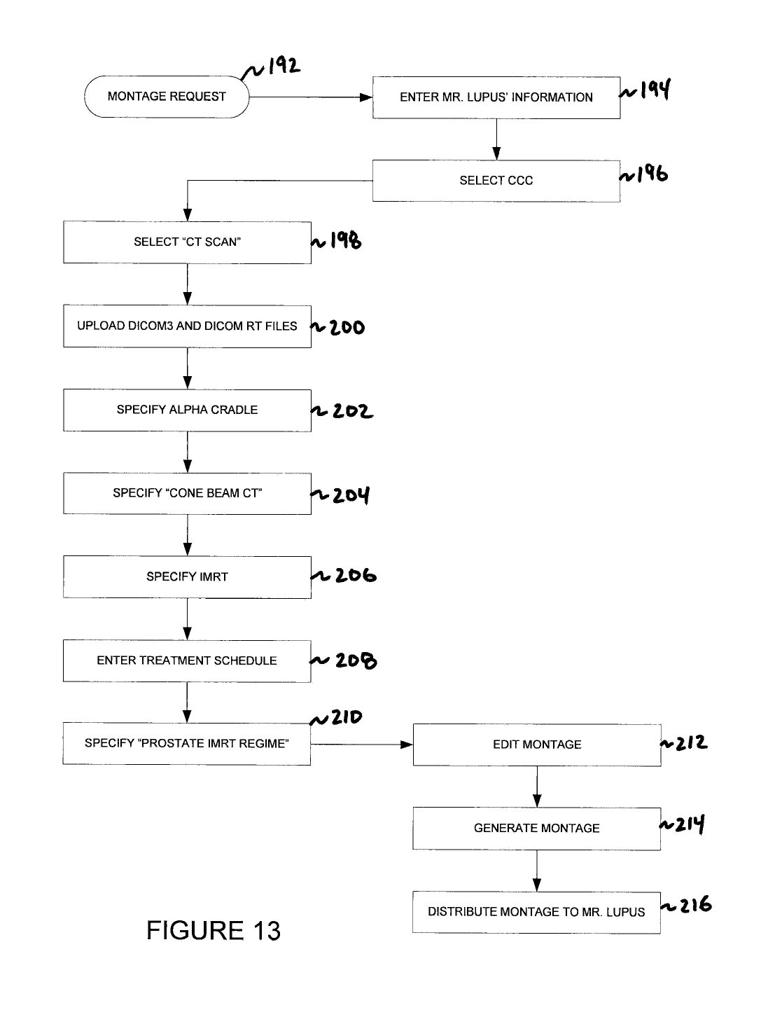

Referring to FIG. 13, an exemplary sequence is provided showing the process of generating a multi-media montage for a patient. A request is made for patient Conrad Lupus at step 192. Mr. Lupus' name, referring physician (Dr. Markum) and his picture are uploaded at step 194, followed by selecting Columbia Cancer Center (CCC) at step 196. CT Scan is selected at step 198 from the modalities library at CCC. DICOM 3 images from a CT scan and DICOM RT files from Mr. Lupus' treatment plan are uploaded at step 200. Alpha cradle is selected from the immobilization techniques within the CCC library at step 202. Cone Beam CT is selected at step 204 from the IGRT modality library. IMRT is selected at step 206 as the treatment modality followed by entering the treatment schedule at step 208. The treatment schedule includes 40 fractions, 5 days/week from July 6 to September 10, excluding holidays. Prostate IMRT follow-up regimen is selected from the follow-up library at step 210. The default montage is edited at step 212. The follow-up instructions are modified to include additional details that benefit Mr. Lupus' treatment, but the default content and sequence order are accepted. The montage is generated at step 214 and provided to Mr. Lupus at step 216.

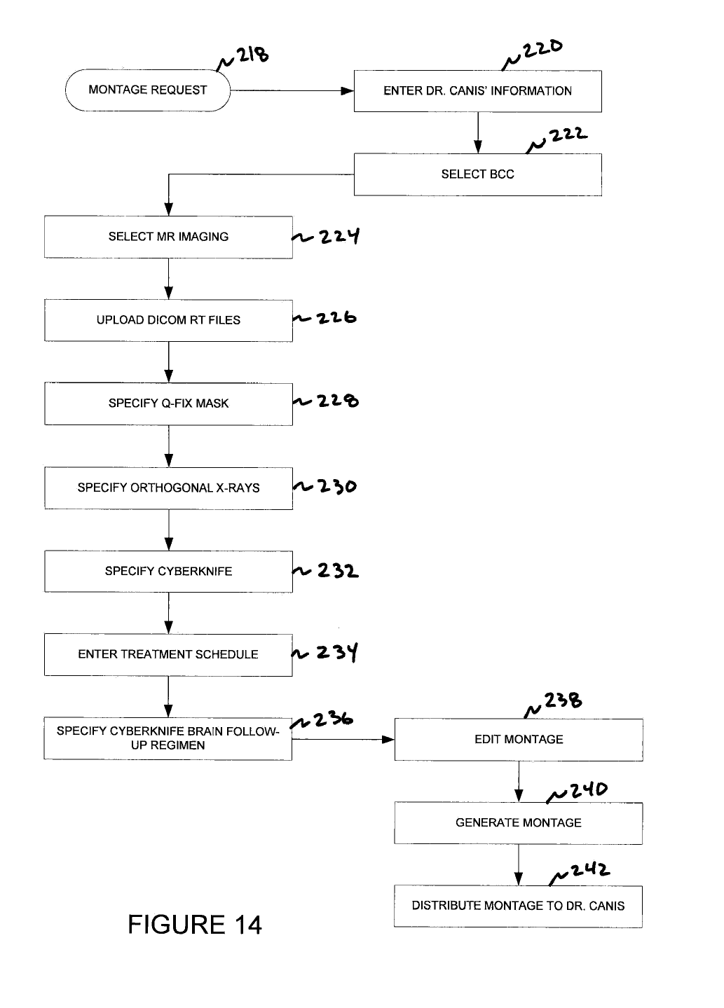

Referring to FIG. 14, an exemplary sequence is provided showing the process of generating a multi-media montage for a patient. A request is made for Dr. Beta Canis at step 218. Dr. Canis' name, referring physician (Dr. Jones) and picture is entered at step 220. The Boone Cancer Center (BCC) is selected at step 222 followed by selecting MR imaging at step 224. DICOM RT files are uploaded from Dr. Canis' treatment plan. The Qfix Mask immobilization technique is selected at step 228. Orthogonal x-rays are selected at step 230 as the IGRT modality. Dr. Canis is being treated by using Cyberknife 232 and his treatment schedule is selected at step 234. In Dr. Canis' case, his treatment schedule includes 5 fractions 1/day on January 1-3 and 6-7. The Cyberknife Brain Follow-up regimen is selected at step 236. The montage storyboard is edited at step 238. Dr. Canis requested that his picture be removed from the montage, the Dosimetry staff picture is removed and the treatment calendar chapter is moved with the sequence to the first chapter. The montage is generated at step 240 and provided to Dr. Canis at step 242.

In at least one embodiment of the invention, the education module includes patient-specific medical data, patient body imaging data, patient-specific radiation therapy planning provider data, patient radiation treatment plan, patient-specific radiation therapy treatment provider data, patient-body positioning data, radiation therapy treatment schedule, and radiation therapy dose delivery data.

In an alternative embodiment, the system 10 includes access to the patient medical data by both the patient and healthcare workers. This access is considered a patient portal and is designed to allow updates and new information to be added, but not for altering or removing existing information associated with the patient. Patients have electronic access, through a password protected means, to provide updates related to their treatment and medical progress. By example, information relating to side effects, medical progress details, and comments relating to treatment can be uploaded by the patient. The patient provided information is stored in a data storage means, such as a hard drive or database structure, which can be relationally oriented to the treatment deliverable. Health care workers, such as nurses and doctors can log into the database and track the information provided by the patient. Additionally, the health care workers can input data relating to the patient's treatment. A patient timeline can be generated, which includes a concise timeline integrating treatment information as well as data uploaded by the patient and health care workers. In at least one embodiment, the portal does not allow data to flow from health care worker to patient, as the connectivity is not designed to be a replacement for medical consultation and direct contact with the patient. In the alternative embodiment, health care workers can assign access permission criteria, which can allow access to the patient and/or certain health care workers.

In an alternative embodiment, patient specific media montages are generated for subjects taking part in outcomes-based clinical studies. Patient subjects are included within a patient feedback loop used to upload comments to a healthcare provider. Comments can be generated based upon the patient's experience, including side effects, health metrics and additional healthcare related information.

In at least one embodiment, the invention includes a method for generating patient-specific radiation therapy (RT) information. The method includes retrieving patient-specific healthcare related data, retrieving RT data associated with a patient, retrieving healthcare provider data based upon a patient-specific treatment plan and converting at least a portion of the retrieved data into computer readable media files. Additionally, the method includes generating a multimedia montage based on the converted data files. The multi-media montage incorporates the healthcare related data, RT data, and the provider data.

According to at least one embodiment, the invention includes a computing device with a central processing unit (CPU) for performing computer executable instructions. The device includes a treatment data storage means for storing radiation therapy data relating to at least one radiation therapy modality, a patient data storage means for storing healthcare related data associated with at least one patient and a provider data storage means for storing healthcare provider data. Additionally, the device includes a memory storage device for storing computer executable instructions that when executed by the CPU cause the CPU to generate a patient-specific radiation therapy media montage. Information contained within the montage is accessed from the treatment storage means, the patient storage means, and the provider storage means.

According to another embodiment, the invention includes a healthcare information delivery system with a central processing unit (CPU) for performing computer executable instructions. The delivery system includes a treatment data retrieval means for accessing and retrieving radiation therapy data relating to a radiation therapy modality, a patient data storage means having healthcare related information associated with at least one patient and a healthcare provider data storage means for storing provider related data. Additionally, the system includes a memory storage device for storing computer executable instructions that when executed by the CPU cause the CPU to generate a patient-specific media montage, wherein the montage is comprised of data accessed from the treatment data retrieval means, the patient data storage means, and the healthcare provider storage means.

According to at least one embodiment, the invention includes a method for providing medical information. The method includes providing a computer executable program, initiating the computer executable program comprising the steps of (1) accessing patient-specific healthcare related data, (2) accessing radiation therapy (RT) data associated with a patient, (3) accessing healthcare provider data based upon a patient-specific treatment plan, (4) converting at least a portion of the accessed data into computer readable media files and (5) generating a multimedia montage based on the data files, wherein the multi-media montage incorporates the healthcare related data, the RT data, and the provider data.

It is specifically intended that the present invention not be limited to the embodiments and illustrations contained herein, but include modified forms of those embodiments including portions of the embodiments and combinations of elements of different embodiments as come within the scope of the following claims.

We claim:

1. A computing device, comprising:
a central processing unit (CPU) for performing computer executable instructions;
a treatment data storage means for storing radiation therapy data relating to at least one radiation therapy modality;
a patient data storage means for storing healthcare related data associated with at least one patient;
a provider data storage means for storing healthcare provider data;
a memory storage device for storing computer executable instructions that when executed by the CPU cause the CPU to generate a patient-specific radiation therapy media montage, information contained within the montage is accessed from the treatment storage means, the patient storage means, and the provider storage means.

2. The computing device according to claim 1, wherein the storage means is a relational database.

3. The computing device according to claim 1, wherein the radiation therapy data is in the form of a DICOM file.

4. The computing device according to claim 3, wherein the DICOM file includes RT plans, RT structures, RT doses, and RT images.

5. The computing device according to claim 3, wherein the radiation therapy data is converted from a DICOM file format to a computer readable multi-media file.

6. The computing device according to claim 1, wherein the radiation therapy data is selected from the group comprising: imaging training, immobilization methods, IGRT training, and treatment follow-up information.

7. The computing device according to claim 1, wherein the media montage provides a radiation therapy patient a substantially comprehensive, interactive and personalized multimedia documentary specific to the patient's radiation therapy treatment.

8. The computing device according to claim 1, wherein information contained within the media montage is accessed from a web-based data structure storing healthcare related information.

9. The computing device according to claim 1, further comprising a web-based data interface for updating patient data relating to ongoing radiation therapy treatment.

10. A healthcare information delivery system, comprising:
a central processing unit (CPU) for performing computer executable instructions;
a treatment data retrieval means for accessing and retrieving radiation therapy data relating to a radiation therapy modality;
a patient data storage means having healthcare related information associated with at least one patient;
a healthcare provider data storage means for storing provider related data;
a memory storage device for storing computer executable instructions that when executed by the CPU cause the CPU to generate a patient-specific media montage, wherein the montage is comprised of data accessed from the treatment data retrieval means, the patient data storage means, and the healthcare provider storage means.

11. The system according to claim 10, wherein the media montage is stored on a portable memory storage device.

12. The system according to claim 10, wherein the montage is comprised of multi-media and includes the following data:
patient-specific medical data,
patient body imaging data,
patient-specific radiation therapy planning provider data,
patient radiation treatment plan,
patient-specific radiation therapy treatment provider data,
patient-body positioning data,
radiation therapy treatment schedule, and
radiation therapy dose delivery data.

13. The system according to claim 10, further comprising a patient data portal for updating patient data relating to ongoing radiation therapy treatment.

14. A computer readable storage medium containing a set of files for a computing device having a user interface, the files comprising:
a radiation therapy (RT) media montage generated for a single patient, the montage comprising data selected from the group consisting of the patient's RT treatment data, healthcare provider data and RT treatment facility data, wherein the montage is an interactive multi-media montage.

15. The storage medium according to claim 14, wherein the RT treatment data includes the patient's RT plan, RT structure, RT dose, and RT images.

16. The storage medium according to claim 14, further comprising a web-interface for dynamically updating patient data relating to ongoing radiation therapy treatment.

17. A method for generating patient-specific radiation therapy (RT) information, comprising the following steps:
retrieving patient-specific healthcare related data;
retrieving RT data associated with a patient, wherein the data exists within a plurality of file formats;
retrieving healthcare provider data based upon a patient-specific treatment plan;
converting at least a portion of the retrieved data into computer readable media files;
generating a multimedia montage based on the converted data files, wherein the multi-media montage incorporates the healthcare related data, the RT data, and the provider data.

18. The method according to claim 17, wherein the file formats are selected from the group comprising DICOM RT files, video files, audio files, text formatted files, and 2D image files.

19. The method according to claim 17, wherein the multi-media montage is a patient-specific radiation therapy documentary configured to provide educational information to a patient undergoing radiation therapy treatment.

20. The method according to claim 17, wherein the RT data is selected from the group comprising imaging training, immobilization methods, IGRT training, and treatment follow-up information.

21. The method according to claim 17, wherein at least a portion of the data contained within the education module is accessed from a web-based server, wherein the server provides healthcare related information.

22. The method according to claim 17, further comprising the step of:
customizing the montage sequence and/or content at least in part based upon a patient and/or healthcare provider data.

23. A method for providing medical information, the method comprising:
providing a computer executable program;
initiating the computer executable program comprising the following steps, accessing patient-specific healthcare related data;
accessing radiation therapy (RT) data associated with a patient, wherein the data exists within a plurality of file formats;
accessing healthcare provider data based upon a patient-specific treatment plan;
converting at least a portion of the accessed data into computer readable media files;
generating a multimedia montage based on the data files, wherein the multi-media montage incorporates the healthcare related data, the RT data, and the provider data.

24. The method according to claim 23, wherein the multi-media file is a saved in a universally readable file format.

25. The method according to claim 23, further comprising:
providing a computing device capable of performing the computer executable program.
